(19) United States
(12) Patent Application Publication
(10) Pub. No.: US 2004/0191450 A1
(43) Pub. Date: Sep. 30, 2004

(54) Coiled linear and tubular formed shapes (techni-coil/ roll-a-pole)

(76) Inventors: Mario F. McGuinness, Bellflower, CA (US); Gaston M. Grant, Newbury Park, CA (US)

Correspondence Address: Mario F. McGuinness, 10328 Trabuco Street, Bellflower, CA, 90706, US

(21) Appl. No.: 10/402,873

(22) Filed: Mar. 26, 2003

(51) Int. Cl. B32B 1/08

(52) U.S. Cl. 428/36.9

(57) ABSTRACT

This invention is an improvement of prior art formed shapes and extrusions. When fabricated with the within described materials such as polycarbonate, spring steel, composites, etc. Due to their inherent spring like quality it allows, formed shapes and extrusions to flatten and fold unto themselves creating a coiled spring like shape. This coiled shape has advantages of ease of handling, space utilization and embedded mechanical energy which prior art linear extrusions lack.

### REFERENCE NUMERALS IN DRAWINGS

30 techni-coil 31 roll-a-pole

32 leading edge 33 trailing edge

34A longitudinal edge 34B longitudinal edge

35 coiled edge 36 flat section

37 thinned wall 38 joining section

39 flexing hinge 40 lever

41 button 42 button arm

43 buttonhole 44 male dovetail

45 female dovetail 46 “S” shape

47 gripping teeth 48 female thread

49 male thread 50 file teeth

51 blade edge 52 saw teeth

53 corner 54 layered material

55 coextrusion 56 electric conductor

57 “C” curve 58 fastener

59 magnetic material 60 abrasive material

61 tube 62 stop tab

63 joining insert 64 window screen

65 closed position 66 open position

67 relief 68 slot

69 banner 70 lighting device

71 rigid sheet 72 roll-a-pole container

73 turn-key 74 threaded hole

75 through hole 76 pipe

77 roll-a-pole clamp 78 roll-a-pole snap lock tube

79 roll-a-pole frame 80 roll-a-pole threaded tube

81 roll-a-pole push clamp 82 roll-a-pole gripping hinge

83 roll-a-pole corner molding 84 roll-a-pole “S” tube

85 roll-a-pole eye tube 6 roll-a-pole quad tube

87 round support tube

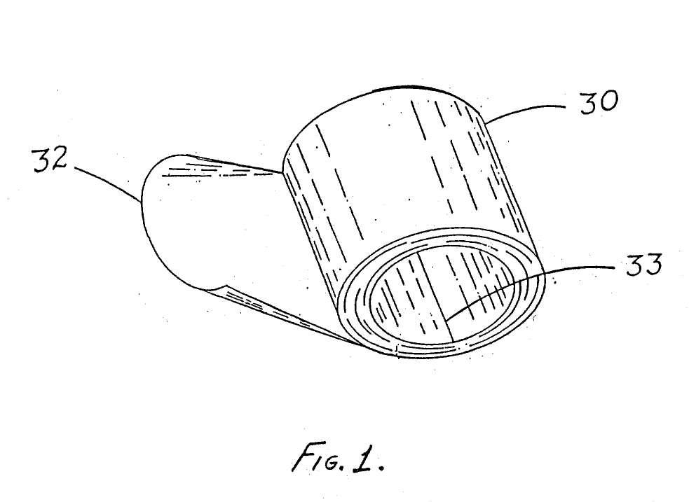

### DESCRIPTION—FIGS. 1 TO 21

FIG. 1 is a perspective view of a typical embodiment of a techni-coil 30 with a leading edge 32 and a trailing edge 33.

The name techni-coil 30 refers to the invention in its coiled or rolled up state. When uncoiled it is referred to as a roll-a-pole 31. The term roll-a-pole(s) and the term roll-a-pole 31 is a term which can represent any roll-a-pole embodiment shown and not shown. The same applies to the techni-coil 30.

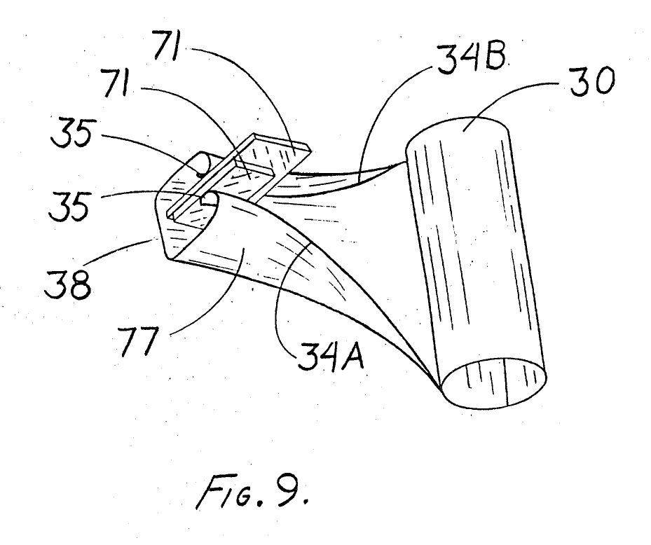

The embodiments of all roll-a-poles may be coiled to form the techni-coil 30. All of the embodiments of the invention can be uncoiled taking the form of the roll-a-pole 31. The roll-a-pole 31 can take many different shapes; one example in FIG. 9, the roll-a-pole 31 becomes a roll-a-pole clamp 77. The roll-a-pole 31 is mainly extruded, it may also be roll formed from sheet material, single or layered and may also be co-extruded with other materials. They maybe pressure or heat formed or both into a particular configuration throughout its longitudinal length and then rolled into the techni-coil 30 perpendicular to its length. Starting with the trailing edge 33 and ending with the leading edge 32, the roll-a-pole 31 is flattened at one end and rolled into a coil becoming the techni-coil 30. The outside edge of the techni-coil 30 is referred to as the leading edge 32.

All of the roll-a-pole 31 embodiments are fabricated from at least a percent of material that have a good spring memory. Polycarbonate plastic and spring steel are preferred for their strong spring-like properties with wall thickness around 0.010 to 0.020 of an inch, increasing and decreasing depending on materials, shapes and design requirements. However, many other plastics, metals, composites, rubbers and other materials and combinations of these can be used; even some materials said to have little or no memory can be co-extruded and or layered along with the materials having strong spring memory making them an integral part of the roll-a-pole.

The main objective in fabricating and designing the roll-a-pole is its ability to be flattened at one end and rolled up into the techni-coil 30 and then has enough spring memory to return close to its original formed shape. When unrolled it becomes one of the roll-a-pole embodiments described herein. Materials, thicknesses and shapes separately and in combination can greatly affect the resulting outcome of the roll-a-pole and techni-coils function. Certain materials thickness and shapes require more force to be flattened, rolled and retained than others. This is one of the considerations to be taken when designing the roll-a-pole shapes.

In FIG. 1 the techni-coil 30 has been partially uncoiled as the leading edge 32 is starting to return to its original formed shape and maybe unrolled in long lengths many times its contained coiled size.

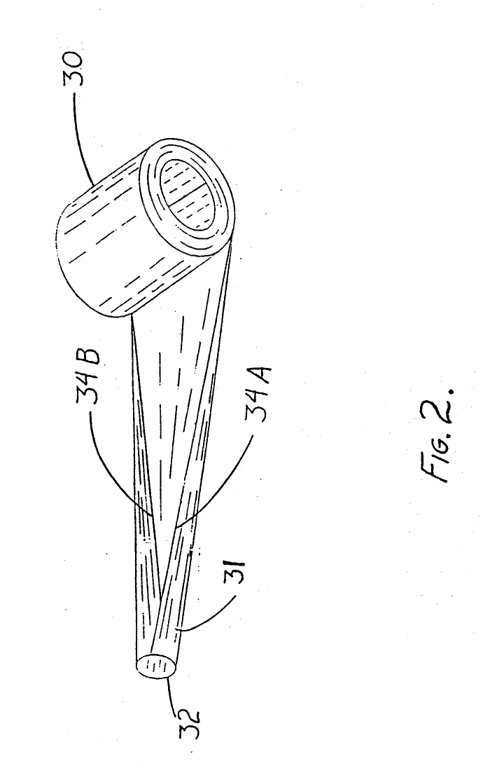

FIG. 2 is a perspective view of the techni-coil 30, the roll-a-pole 31 with the leading edge 32, a longitudinal edge 34A and a longitudinal edge 34B.

The techni-coil 30 is uncoiled further than seen in FIG. 1 and the roll-a-pole 31 is returning with the leading edge 32 to its original formed shape. In this embodiment it is a circular tube shape about one inch in diameter. The longitudinal edge 34B is being overlapped by the longitudinal edge 34A. All sizes, shapes and thickness throughout all of the embodiments can be varied depending on their desired use.

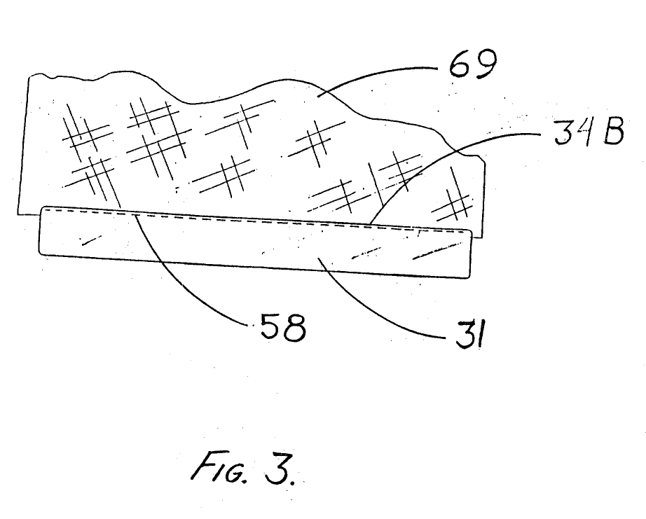

FIG. 3 is a perspective view of the roll-a-pole 31, a banner 69 (partially shown), and a fastener 58 and the longitudinal edge 34B.

The roll-a-pole 31 has been completely unrolled in its length and held flat by means not shown. Near its longitudinal edge 34B the banner 69 is secured by the fastener 58. The fastener 58 in this example is stitching. If the roll-a-pole 31 is made from thin wall plastic the stitching operation can be achieved by the use of a commercial sewing machine used in the industry. The fastener 58 can be any common method of fastening used in industry such as heat sealing, adhesives, tapes, staples, etc.

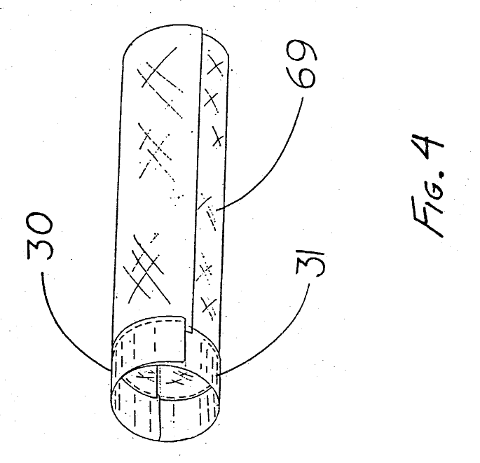

FIG. 4 is a perspective view of the roll-a-pole 31, the techni-coil 30 and the banner 69.

The roll-a-pole 31 while attached to the banner 69 as shown in FIG. 3 has been rolled into its smaller coiled condition becoming the techni-coil 30 again and ready for shipping.

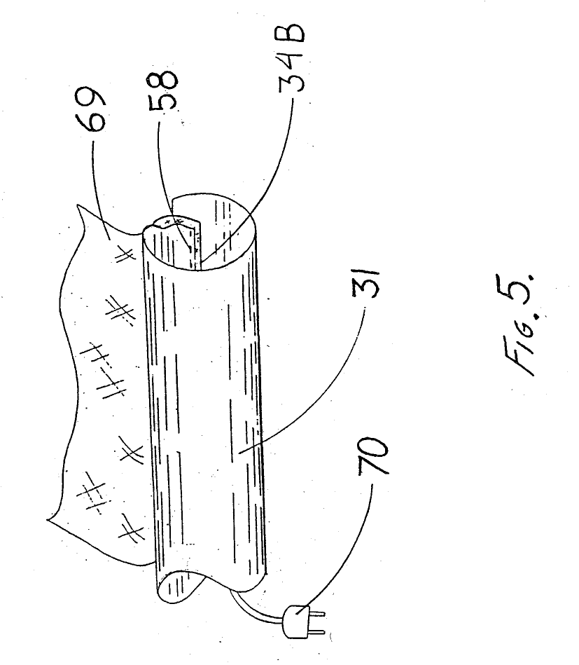

FIG. 5 is a partial perspective view of the banner 69, the fastener 58, the roll-a-pole 31 (partially shown), the techni-coil 30, the longitudinal edge 34B and a lighting device 70.

The roll-a-pole 31 has been uncoiled from its techni-coil 30 condition (shown in FIG. 4) along with the banner 69. Part of the roll-a-pole 31 has been removed for viewing, revealing the longitudinal edge 34B as it is attached to the banner by the fastener 58. In FIG. 3, the roll-a-pole 31 was flattened and attached to the banner 69 while in a flat condition. In FIG. 4, the roll-a-pole 31 along with the banner 69 is rolled up for shipping into the techni-coil 30 shape. And now in FIG. 5 they were uncoiled after shipping and the roll-a-pole 31 is offering rigid support to the banner 69. The lighting device 70 (partially shown) has been added with a length of common Christmas tree lights. Many other types will work. The lighting 70 can be seen through the roll-a-pole 31 if made from a clear or translucent plastic. The lighting device 70 can also represent an electric wire without lights acting as a conductor and turning the roll-a-pole into conduit.

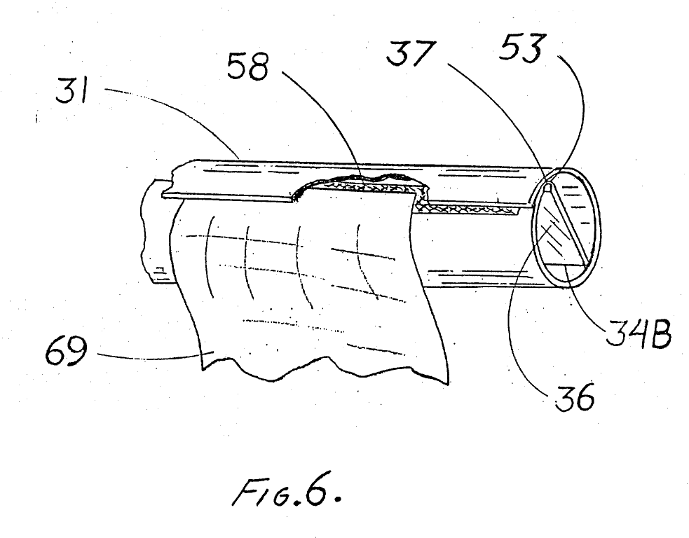

FIG. 6 is a partial perspective view of the roll-a-pole 31, the banner 69, the fastener 58, a flat section 36, a thinned wall 37, a corner 53, and the longitudinal edge 34B.

The roll-a-pole 31 and the banner 69 are fastened in this example using double backed tape as the fastener 58. The double backed tape can be applied before the role-a-pole 31 is coiled up into the techni-coil 30 in manufacturing as double backed tape often has a protective backing (not shown) that can be peeled off when ready for use. The tape can serve two purposes in this application. First, to seal the role-a-pole 31 making it a completely sealed tubular construction and second, to secure the banner 69 to the roll-a-pole 31. However, the tape can be applied after the roll-a-pole 31 has been uncoiled from its techni-coil 30 form, if desired.

The flat section 36 can be added and take other forms. If desired, its function can be to act as an internal stiffener. It is illustrated at about a 90 degree angle and this angle can be altered if desired. If need be it can be on the outside of the roll-a-pole 31 or on the inside as shown and could be in plurality, if desired.

The thin walled section 58 has been formed into a corner 53 with a small radius and also acts as a hinge. Thin walled sections can be used throughout all the roll-a-pole embodiments for extra flexing in numerous designs not shown.

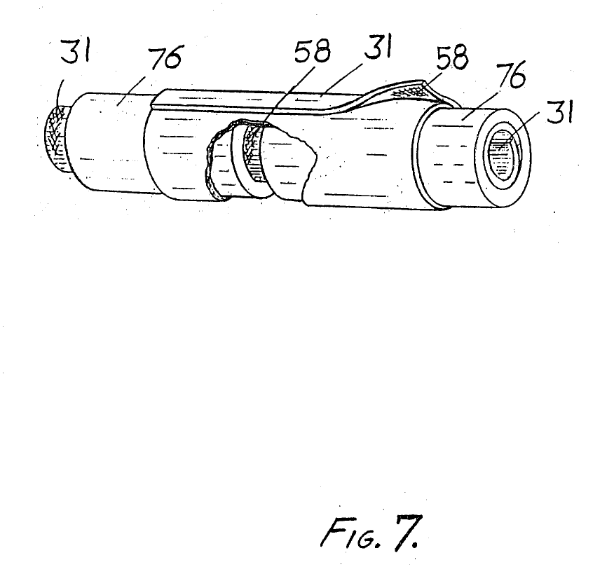

FIG. 7 is a perspective view of the roll-a-pole 31 in plurality and a pipe 76 in plurality and the fastener 58 in plurality.

The pipe 76 is being joined to another pipe 76 by the roll-a-pole 31 on the inside and then again by another roll-a-pole 31 on the outside. The fastener 58 in this application could be an adhesive that is applied in manufacturing internally or externally or both on the surfaces of the roll-a-pole. The methods and adhesives used in industry for-manufacturing tapes of many types can apply. Adhesives of many types used in industry can be applied to the roll-a-pole 31 during this type of joining. Adhesives are not a requirement to join the pipes 76. The roll-a-pole 31 can act as an internal or external spring clamp increasing or decreasing in its diameter. The pipe 76 is just one sample of an item being joined or repaired. It can also be a solid rod (not shown) or pole or a group of wires or any number of items to be held together. The roll-a-pole 31 can be cut with a knife or scissors to the needed length and act as a repair or joining clamp or rigid tape or both.

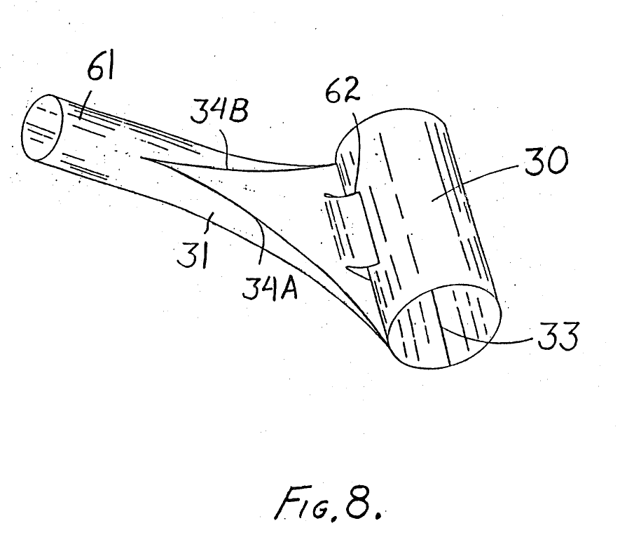

FIG. 8 is a perspective view of a tube 61, the techni-coil 30, a stop tab 62, the longitudinal edge 34A, the longitudinal edge 34B, the trailing edge 33 and the roll-a-pole 31.

The tube 61 is any tube of any shape not just round as illustrated that when partially split along its length and flattened at trailing edge 33 it may be rolled into the techni-coil 30. It has to meet the characteristics of materials earlier stated in FIG. 1 to achieve this feat. The splitting of the tube creates the longitudinal edges 34A and 34B.

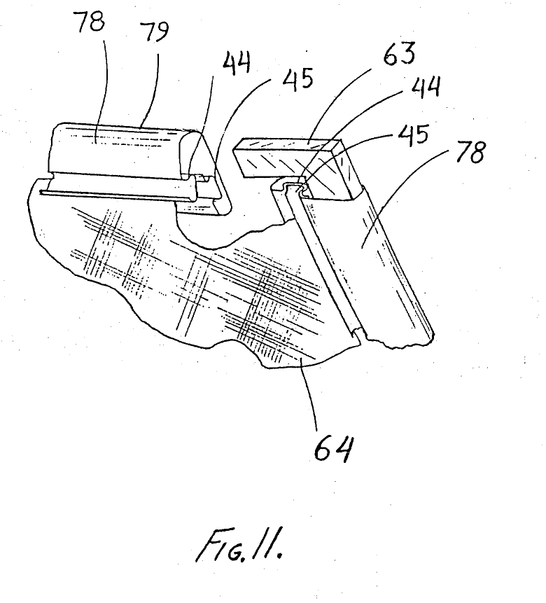

The stop tab 62 is fabricated with methods described in FIGS. 12, 13, 18 and 21 for features which are added to the roll-a-pole. The stop tab may be added singularly or in plurality in any desired location.

The splitting of the tube creates the longitudinal edges 34A and 34B and when split completely in its length all of it may be rolled into a techni-coil.

FIG. 9 is a perspective view of a roll-a-pole clamp 77, a plurality of a coiled edge 35, a joining section 38, the longitudinal edge 34A, the longitudinal edge 34B, a rigid sheet 71 in plurality and the techni-coil 30.

It is fabricated from earlier mentioned methods and materials. The longitudinal edge 34A and the longitudinal edge 34B have been formed to create the coiled edge 35 in plurality. The joining section 38 edge connects them together and may take many forms other than illustrated. The coiled edge 35 may be used once if desired or even eliminated and clamping can still be achieved. Due to the inherent spring properties of the materials and if the clamp 77 is shaped in such a fashion that it could clamp parts. One example would be if it was “U” shaped (not shown). The coiled edges may vary in size and position to each other. Many design variations are possible depending on the type and strength of the clamp requirements. Sheet 71 is clamped to another sheet 71 and represents any sheets or parts that may be clamped together. More or less than two sheets or parts can be clamped. As other roll-a-pole configurations, it can be coiled up into the techni-coil 30 shape after its extrusion or forming and then uncoiled for use as needed.

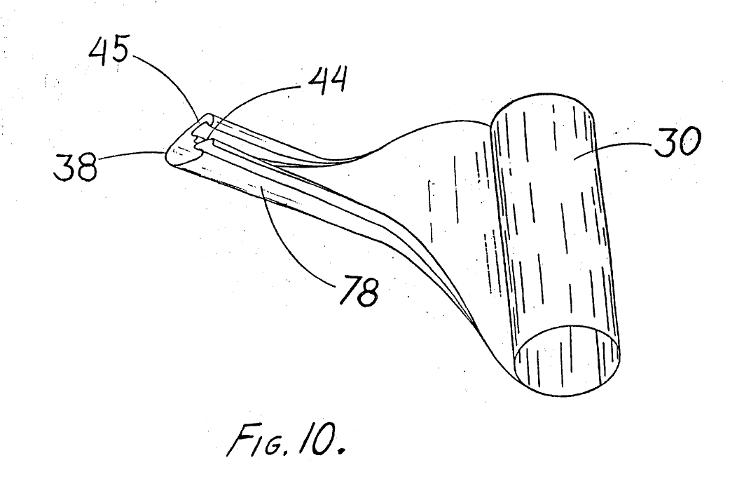

FIG. 10 is a perspective view of a roll-a-pole snap lock tube 78 with a male dovetail 44, a female dovetail 45, the joining section 38 and the techni-coil 30.

The snap tube 78 is fabricated from earlier mentioned methods and materials. It consists of a male dovetail 44 and a female dovetail 45. They can be the same size or different. If the same, the material can spring open enough on one and compress on the other to snap together. They can be formed with a radius shape as shown or they can have sharper corners as shown in FIG. 10A. They represent common fastening shapes used in industry that may not take the shapes of dovetails. Their radius and shape along with size and material thickness are all relevant to their application or force required to snap them closed. Too small a radius on too thick a material offers greater resistance when being flattened to roll up into the techni-coil 30 shape. As a base rule the thinner the wall, the smaller the radius. Dovetail joints and snaps of many types in many positions can be fabricated to close and seal various shapes. One example is a tongue and groove formed into the longitudinal edges 34A and 34B allowing them to butt together and lock. See FIG. 10A.

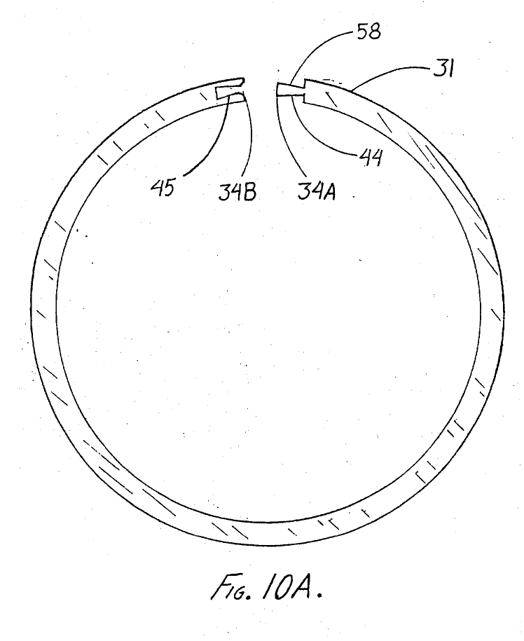

The other design criteria are that the dovetail 44 and dovetail 45 align to be pressed together. Slight design variations will allow the male dovetail 44 to rotate while entering the female dovetail 45, thus acting more like a cam. The joining section 38 as mentioned earlier can take many forms and in this particular embodiment also acts as a flexing hinge. The dovetail 44 and the dovetail 45 can be designed to snap and lock together or to have clearance to lock material of different thickness between them. One example is shown in FIG. 11.

FIG. 10A is an end view of the roll-a-pole 31, the longitudinal edge 34A, the longitudinal edge 34B, the female dovetail 45, the male dovetail 44 and the fastener 58.

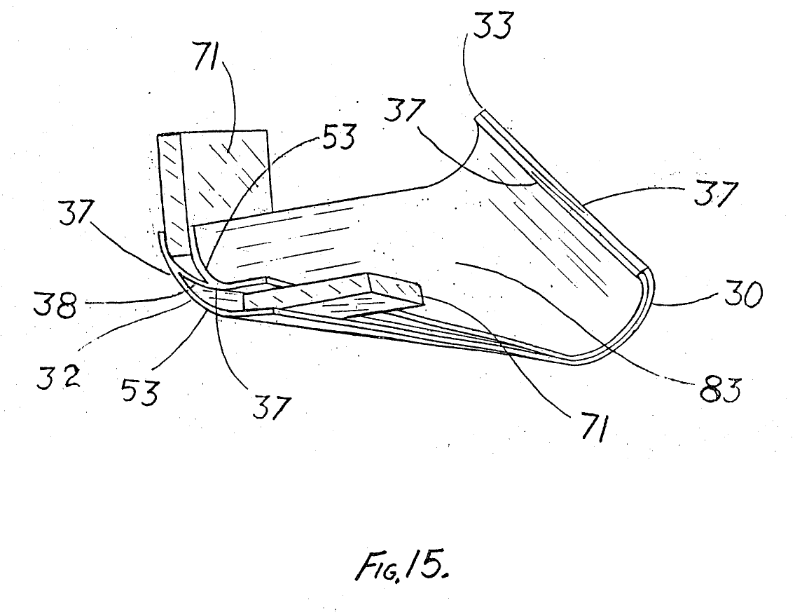

Illustrating another fastening and sealing method, the roll-a-pole 31 has been modified. The dovetail shapes 44 and 45 are formed down the length of the longitudinal edge 34A and the longitudinal edge 34B. The dovetails 44 and 45 are forced together, fastening and sealing the roll-a-pole 31 creating a closed tubular shape. This forcing action can be achieved by the spring action of the techni-coil 30 (not shown) returning to its original formed roll-a-pole 31 shape or by a mechanical guide (not shown) that could be part of the container tube 72 in FIG. 16 or squeezed by hand to close the edges 34A and 34B together. The dovetails 44 and 45 could be formed in an extrusion process as mentioned earlier. The fastener 58 in this case, an adhesive, can be applied with methods known in the industry and is not required to seal the roll-a-pole 31, but can be used to enhance its sealing or locking strength.

FIG. 11 is a partial perspective assembly view of a roll-a-pole frame 79, the snap tube 78 in plurality, a joining insert 63, a screen 64, the male dovetail 44 and the female dovetail 45.

The snap tube 78 shown in FIG. 10 may be used in multitude to build the partially shown roll-a-pole frame 79. This frame could have four lengths of the snap tube 78 along with four joining inserts 63 to complete a square frame (not shown completely). The frame 79 represents any frame of any configuration that could be fabricated and assembled with the use of the roll-a-poles. The joining insert 63 is shown as a right angle corner joint but represents any common joining shape such as a “T” shape, “+” cross shape, butt joint shapes that would be straight and a number of shapes not shown.

The screen 64 represents just one sample of a flexible material that may be clamped by the snap tube 78. Rigid sheet materials (not shown) could be clamped in numerous

arrangements with some obvious modifications (not shown) to the snap tube 78. The snap tube 78 may be used in a length by itself without the inserts 63, if desired as a type of snap closed banner dowel or mounted on a wall or surface to grip posters and paper (not shown), etc. The insert 63 could be hollow (not shown) to provide clearance for wire, liquid, gases and so on. The frame shown in this figure can be assembled by connecting lengths of the snap tube 78 and using a multitude of the inserts 63 to create a square frame. The screen 64 can then be placed between the male dovetail 44 and the female dovetail 45 and then snapped closed completing the frame 79 assembly and securing the screen 64.

FIG. 12 is a perspective view of a roll-a-pole threaded tube 80, a female thread 48 in a multitude, a male thread 49 in multitude, a file teeth 50 in multitude, a abrasive material 60 and the roll-a-pole 31.

The roll-a-pole threaded tube 80 is a modified version of the roll-a-pole 31 which consists of small cut out tabs that are bent up and arranged in a spiral pattern creating internal or external threads. These tabs are referred to as the female thread 48 and the male thread 49. The fabrication of these threads 48 and 49 may be achieved while the roll-a-pole 31 is forced into a flat position as shown in FIG. 3. Punching and forming operations are common in the sheet metal industry and may be used to accomplish this task. The material choice for this embodiment would more likely be spring steel. As earlier mentioned, small and large cut out tabs are capable of being rolled up with and into the techni-coil 30, since they can flatten themselves out during the rolling process. The file teeth 50 can be integrated in multitude and their fabrication can be similar to the process used to create the threads 48 and 49. They may be ground in an additional operation giving them a sharp edge if desired. The file teeth 50 can also be used on a roll-a-pole 31 when shapes and surfaces are accommodating. The abrasive material 60 could be secured by an adhesive (not shown) or may be imbedded into hot extruded plastic, if that is the material of choice. It is unlikely that threads 48 and 49 along with the file teeth 50 and the abrasive 60 would all be used on the same tube. It is grouped together in this FIG. 12 only for illustration.

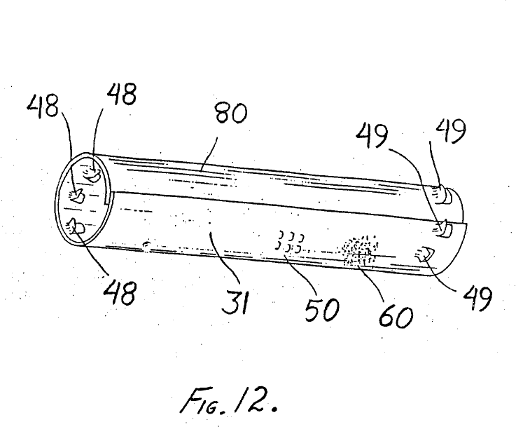

FIG. 13 is a partial perspective view of an embodiment of a roll-a-pole push clamp 81, a lever 40, a through hole 75, a threaded hole 74, a gripping teeth 47 in a set, a flexing hinge 39, a magnetic material 59, a open position 66 and a closed position 65.

The push clamp 81 is fabricated with earlier mention&d methods and materials. FIG. 13 shows one of many shapes that will create the push clamp 81. The gripping surfaces are created by the longitudinal edge 34A and the longitudinal edge 34B. The set of gripping teeth 47 can be added to the longitudinal edge 34A and 34B, if desired. The basic design criteria required for the push clamp 81, would be for two surfaces that are normally closed, in this case, the longitudinal edges 34A and 34B. They may be opened or separated with the aid of a joint, in this case, the hinge 39, add by actuating a device, in this-case, the lever 40. Position 65 and 66 shown are open and closed positions. The through hole 75 and the threaded hole 74 can be added, they can be punched along with the set of gripping teeth 47 in a second operation with methods described in FIG. 12. Threaded holes are common in sheet metal parts and very often have the hole edges deformed slightly, depending on what type of threads is on the mating screw (not shown). The magnetic material 59 can be magnetized metal embedded into the surface of the clamp 81 if it is fabricated from plastic. If it is fabricated from metal, the metal itself could be magnetized by methods used in industry.

Sizes, shapes and configurations shown in FIG. 13 can all be altered depending on the application requirements of the press clamp 81.

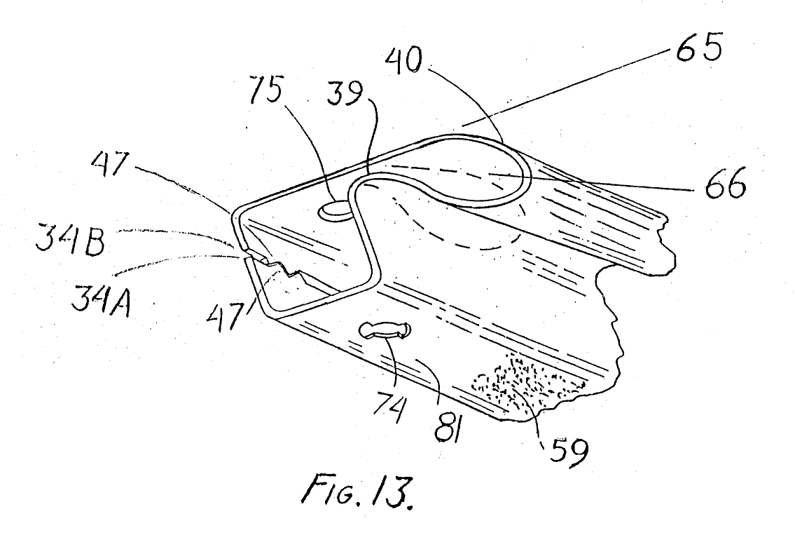

FIG. 14 is a perspective view of a roll-a-pole gripping hinge 82, a rigid sheet 71 in plurality, the coiled edge 35 in plurality, the longitudinal edge 34A, the longitudinal edge 34B, the joining section 38, the flexing hinge 39, the closed position 65 and open position 66.

The gripping hinge 82 is fabricated from earlier mentioned materials and methods. It can take many forms, in this particular figure both the longitudinal edge 34A and the longitudinal edge 34B represent the peripheral edges of the formed coiled edge 35, which are tied together by the joining section 38. The positions 66 and 65 represent open and closed positions, and may vary in their range of movement, depending on design. The coiled edges 35 can be sized to grip different thicknesses of the rigid sheet 71 but due to their flexing properties might not need to. Fasteners (not shown) can be utilized to secure the sheets 71 further if desired. The flex hinge 39 in this embodiment is the spring like flexing action of the joining section 38. The rigid sheet 71 is shown for reference-only and may of course represent any material utilized.

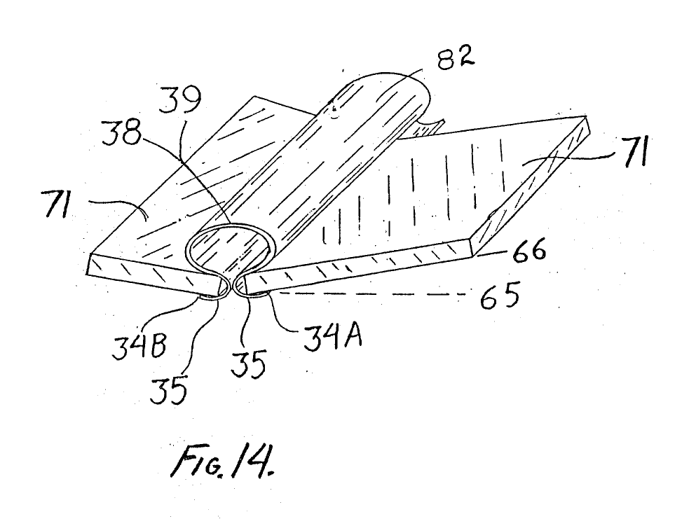

FIG. 15 is a perspective view of a roll-a-pole corner molding 83, with the corner 53 in plurality, the thinned wall 37 in plurality, the joining section 38, the techni-coil 30 partially coiled, the trailing edge 33, the leading edge 32 and the rigid sheet 71 in plurality.

The corner molding 83 is preferably extruded from plastic earlier described. The corners 53 are held together by the joining section 38. The sheet 71 may be held between the corners on both sides. The corner molding 83 is shown partially rolled in the techni-coil 30. The thinned wall 37 shown in the leading edge 32 is distorted in the perspective view, but is clearly seen in the trailing edge 33 in two places. They may be used to shape the walls of the corners 53, as seen in the trailing edge 33, so they can lay flat along with the joining section 38, keeping a consistent thickness while they are all sandwiched together as they flatten and roll into the techni-coil 30. Thinned walls can also be used as flex hinges in this and other embodiments. The corner molding may be made in angles other than the right angle illustrated.

FIG. 16 is a perspective view of a roll-a-pole container 72, comprised of the roll-a-pole 31, the longitudinal edges 34A and 34B and a blade edge 51. Within the roll-a-pole container 72 is seen a techni-coil 30 and partially uncoiled from it, the second roll-a-pole 31 shown with phantom lines, and the leading edge 32.

The container 72 is a short length of the roll-a-pole 31. It is fabricated with earlier mentioned methods and materials. Its wall thickness may be heavier than the wall thickness of the techni-coil 30 it is used to retain. The gap between the-longitudinal edge 34A and the longitudinal edge 34B provide a space for the inserted techni-coil 30 shown in phantom lines to be released. As the leading edge 32 emerges from the techni-coil 30 and the uncoiled portion starts to return to its original formed roll-a-pole configuration shown in phantom lines.

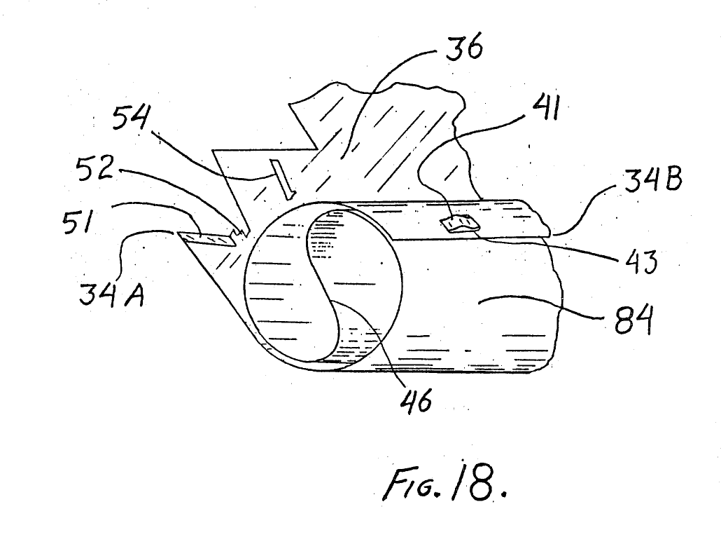

The container 72 can also be made from a non roll-a-pole plastic or metal tube of almost any standard type (not shown) with a long slot through its wall in the direction of its longitudinal axis. The slot in the tube would function as the gap between the longitudinal edge 34A and 34B in the roll-a-pole container 72. Either container can be used to retain any of the roll-a-pole embodiments when rolled into the techni-coil 30. The blade 51 may be formed in the longitudinal edge 34B or the edge of the slot in the tube just mentioned using methods described in FIG. 18. Other containers, such as reels, boxes, spools, etc. even mechanized ones though not shown may also be used to store the techni-coil and dispense the roll-a-pole.

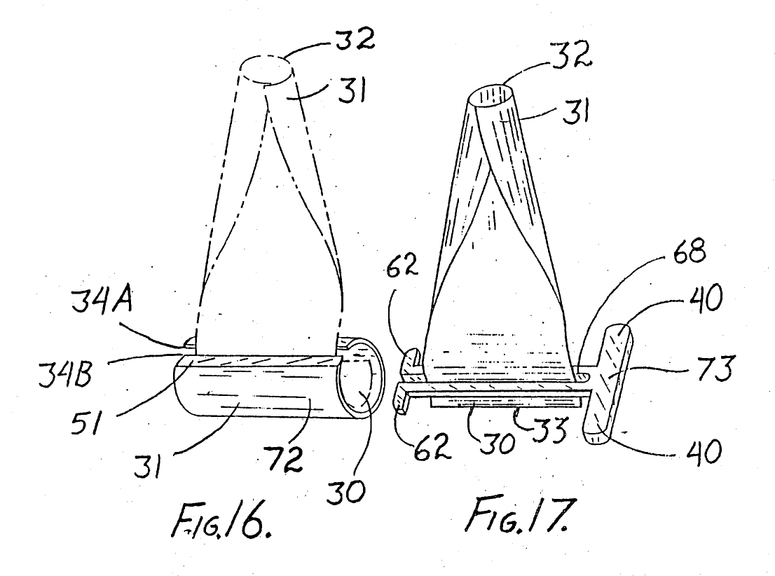

FIG. 17 is a perspective view of a turn key 73 assembled with the roll-a-pole 31, the leading edge 32, the trailing edge 33, a slot 68, the lever 40 in plurality, the stop tab 62 in plurality and the techni-coil 30.

The turn key 73 can be fabricated from metal or plastic using common manufacturing methods. Its thickness should be greater than the gap between the longitudinal edge 34A and 34B of the container 72 shown in FIG. 16. This prevents it from catching in the gap and not being able to turn.

The roll-a-pole 31 is inserted through slot 68 in the turn key 73 near its trailing edge 33. The roll-a-pole 31 is then coiled around the turn key 73 to create a complete techni-coil 30 (not shown). The turn key 73 with the techni-coil 30 is then inserted into the container 72 shown in FIG. 16. The stop tabs 62 are compressed towards each other as they pass through the container 72 during this assembly. Once they pass the far end of the container 72, they sprig back to their original position thus locking the turn key 73 with the techni-coil 30 inside the container 72. The leading edge 32 of the techni-coil 30 can be fed through the gap between the longitudinal edge 34A and 34B of the container 72. The levers 40 on the turn key 73 can then be turned to drive the techni-coil 30 in and out of the container 72. When driven out it takes the form of the roll-a-pole 31. FIGS. 16 and 17 represent only one design to achieve a means of dispensing the roll-a-pole. As stated in FIG. 16 there may be many others.

FIG. 18 is a partial perspective view of a roll-a-pole “S” tube 84 with a “S” shape 46, a number of saw teeth 52, the blade edge 51, a button 41, a buttonhole 43, the longitudinal edge 34A and 34B, the flat section 36, and a layered material 54.

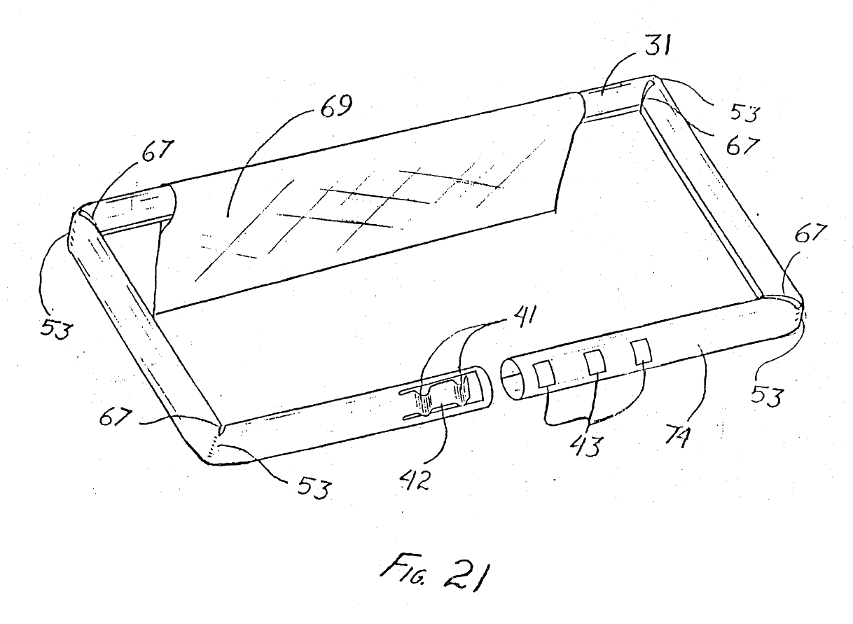

The “S” tube 84 is fabricated with-earlier mentioned methods and materials. It consists of an “S” shape 46 that continues in a circular direction forming the “S” tube 84. Additional features have been added in this figure. The flat section 36 is added, extending the longitudinal edge 34A. The blade edge 51 has been formed on that edge and would be created by a number of methods used in industry, such as grinding, pressing, coining etc. The saw teeth 52 have also been added to that edge and would be made with methods described in FIG. 12. The flat section 36 can extend further than illustrated and could be used as a sign face and the “S” tube could act as its support. The layered material 54 could represent any number of materials such as ink, paint, metals, fabrics, plastics, etc. and can be applied in various methods used in industry. In this particular figure it is paint and can be applied to the flat section or curved section by common methods used in the industry. The layered material 54 can be multi-layered with different materials. The button 41 and the buttonhole 43 are illustrated and described better in FIG. 21 and the operation section.

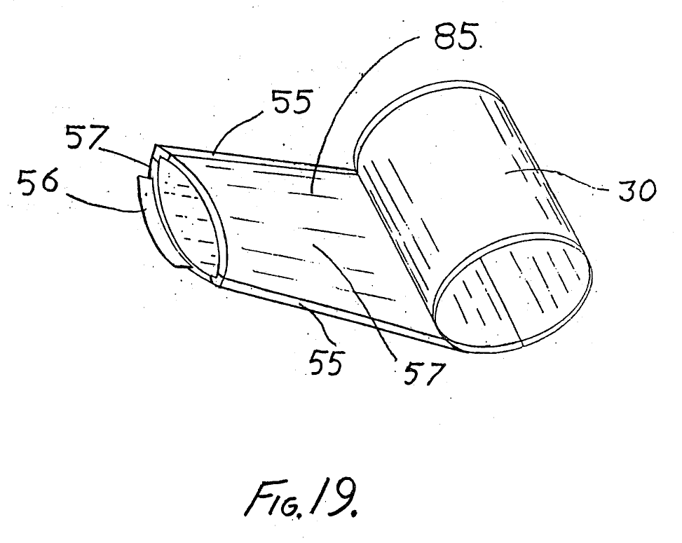

FIG. 19 is a perspective assembly view of a roll-a-pole eye tube 85, the techni-coil 30, a “C” curve 57 in plurality a co-extruded material 55 in plurality, and a electric conductor 56.

The eye tube 85 partially coiled into the techni-coil 30 consists of the “C” curve 57 in plurality, which can be plastic or rubber and could be metal if the conductor 56 is not used. Whatever material is used, it should have the spring characteristics that are consistent throughout the roll-a-pole embodiments. The two “C” curves 57 are joined together by the co-extruded material 55 on each side which is a plastic or rubber of a flexible type. They provide a type of flexible hinge that holds the more rigid “C” curves 57 together. This creates a new type of roll-a-pole that is sealed and closed all around its perimeter and can all be extruded together. If the “C” shape 57 is plastic or rubber the conductor 56 may be encased within the extrusion as illustrated. The conductor 56 is shown as a curved metal that is co-extruded along with the plastic “C” curve 57. However, it could take many shapes, such as copper wire strands that are extruded along with plastic and rubber in the manufacturing of common electric insulated wire. If the “C” curve 57 is metal such as spring steel, they can be fed through an extrusion machine alongside the coextrusion 55 creating a closed tube and acting as a flexible hinge joining the two “C” curves 57 together. Two or even one “C” curve 57 can be metal and be partially or completely surrounded by the coextrusions 55 flexible material. Another method shown in FIG. 6 can also apply. FIG. 6 illustrates another type of hinge. The thin wall 37 along with the corner 53 could be used to replace the flexible coextrusion 55 material, and make a complete closed eye tube 85 out of a single material. Some experimentation might be required.

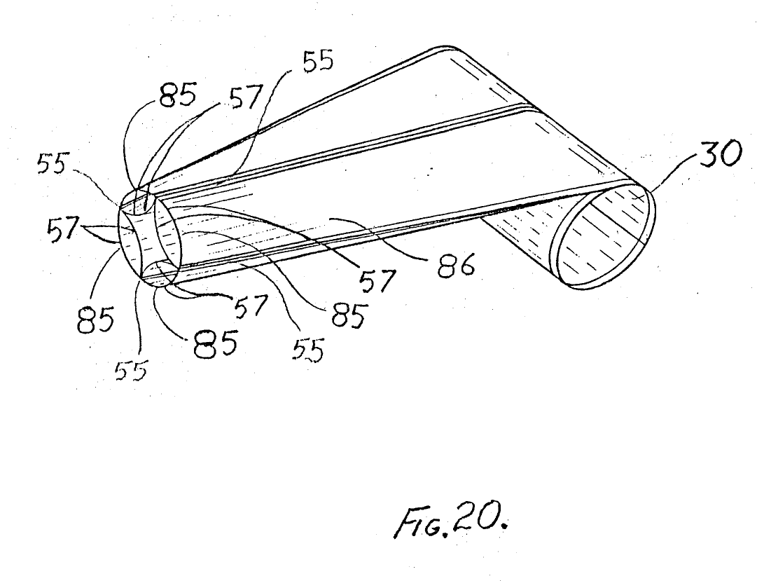

FIG. 20 is a perspective view of a roll-a-pole quad tube 86, the eye tube 85 in plurality, the techni-coil 30, the “C” curve 57 in plurality and the coextrusion 65 in plurality.

The quad tube 86 can consist of four eye tubes 85 co-extruded together then being rolled up to create the techni-coil 30. The arrangement illustrated is not the only possibility. As an example, the outer “C” curves 57 could be excluded from this combination leaving just the inner “C” curves 57 joined by the coextrusion 55 creating a type of square tube with four concave curved walls. Materials and methods used for the roll-a-pole eye curve 85 could apply in the manufacture of the roll-a-pole quad tube 86 and other tubular arrangements mentioned.

FIG. 21 is a perspective assembly view-of a roll-a-pole frame 79, a relief 67 in plurality, the buttonhole 43 in plurality, the button 41 in plurality, a button arm 42, the banner 69, the corner 53 in plurality, and the roll-a-pole 31.

The roll-a-pole 31 has been modified creating the roll-a-pole frame 79. The button arm 42, the buttons 41 and the buttonholes 43 along with the relief 67 are fabricated by methods common in the metals industry and such methods can also apply to materials selected herein. Thermoforming is one method that could apply when shaping features in plastic. However, care should be taken when using heat on extruded forms. It should be localized to prevent distortion of surrounding surfaces. Button 41 and buttonhole 43 singularly as shown in FIG. 18 or in plurality, may or may not require the button arm 42. However used, they can lock the roll-a-poles in circumferential and/or linear lengths or both. The buttons 42 should be formed high enough to protrude through the buttonholes 43.

Methods described in FIG. 12 can also apply in the fabrication of the added features mentioned. The relief 67 shown in four places is formed by cutting away enough material to allow the roll-a-pole 31 to bend creating the corner 53, the banner 69 is a standard type used in industry.

Roll-a-pole shapes shown throughout the FIGS. 1-21 are representative samples of shapes and configurations. Many of them can be modified or customized to fill specific needs. It would be impossible to show their every conceivable shape and use.

In designing and manufacturing the roll-a-pole most every fabrication methods used in the metals, plastics and extrusion industries can apply. Common features for fastening, joining, and assembling can often be used.

The main design concern to be applied to manufacturing the roll-a-pole products is that whatever the shape, material and added features, all roll-a-pole products should be capable of rolling into the techni-coil and be unrolled for use. Mixing and matching herein described features and similar features used throughout industry, as well as common shapes for uses described and not described but are obvious, can apply to hundreds of possible products and uses. There are too many to illustrate. Containment of long tubular shapes that have spring-like characteristics cannot only provide structural support but can also perform work as they have spring energy stored within. Not only is the minimal space a tremendous advantage but the fact that after uncoiling to their roll-a-pole shape, the movement and stored spring energy makes their application and benefit endless.

The designed shape of the fabricated length of the roll-a-pole whether extruded or formed by other means, is best seen from its end view and is or mimics an extruded shape.

Since the end view of any extrusion is designed with geometric features of curves, straight lines and angles, the shape of the roll-a-pole may be designed from a single and also a combination of these features. Just as the shape of extrusions that are manufactured for industry and private use are infinite. So may that of the roll-a-pole be. Care needs to be taken in selecting materials not to allow any portion of the end view design to be structurally so rigid as to prevent the roll-a-pole to be rolled into a coil, to form the techni-coil.

These shapes, curves, flats, and angles in various combinations not only have the capability of developing structural configurations, but can become features stable or flexing depending on their designed function. Thick rigid wall sections curved or flat can act as stationary structural elements. Thinner curved or flat sections can be designed to flex or give. However, thick or thin, curved or straight can be designed to be stable or to flex. The inherent spring properties of the roll-a-pole in more than one direction provides stored spring force to these shapes giving them the ability to clamp, flex, grip, snap, lock, hinge, and return, apply pressure internally and externally on other features of their own embodiment as well as upon outside elements, materials and parts. These spring properties can also be applied to the added features and accessories such as button arms 42, tabs 62, etc. This spring force may turn the roll-a-pole into a machine with stored energy capable of performing useful work after it is unrolled from its small contained size as a techni-coil.

### OPERATIONS—FIGS. 1 TO 21

FIG. 1—The roll-a-pole formed shape has been rolled into the coiled shape of a techni-coil.

FIG. 2—The techni-coil from FIG. 1 is being unrolled to form the roll-a-pole ready for use. In this particular view the roll-a-pole that is emerging is taking the shape of a round tube and can be used in hundreds of applications that require round tubes.

The fact that it is unrolling from a much smaller coiled shape (the techni-coil) adds to its potential number of uses and applications. The tremendous convenience, for example, of being able to go to a store and buy a 20 foot long tube in a coiled shape so small it could be put in your shirt pocket and not having to use a truck to transport it.

Another advantage is putting the techni-coil in your tool box and being able to use it on the spot for a particular job and only unrolling as much as you need, for many of the role-a-poles can be cut with a scissors or a knife. The container 72 shown in FIG. 16 can be equipped with a blade that can be used to cut the roll-a-pole to a given length similar to a common tape dispenser. The container 72 would most likely be the retaining device that the techni-coil would be sold in. A rubber band, a wire tie, a string, duct tape and other containment methods may also be used.

This capability of unrolling and cutting on the spot, this rigid tube like structure, the roll-a-pole is very handy to join poles and pipes as shown in FIG. 7. Here it is used like a roll of duct tape yet structurally rigid. It can be used on the inside diameter of a pipe or on the outside diameter.

It not only adds structural support but is capable of clamping internally and externally. Double backed tape or adhesive can also be applied enhancing its joining and repair applications. This is covered further in the description section on FIG. 7. Transporting, shipping, handling, packaging, boxing and storage of many long tubular shapes will be a lot easier and less costly when they are replaced by the roll-a-pole in its compact techni-coil size. Many drawings, photos and other items are shipped in tube like containers, usually cardboard. These shipping tubes are very expensive and take up large amounts of space. They are manufactured in a hollow tubular form and waste space in their manufacturing place of origin and are then shipped hollow and unused to a consumer who then takes up space again to store them until they are finally filled with the drawing or photos or other items. Only then is that hollow waste of space used. The roll-a-pole can be unrolled of its much smaller techni-coil condensed form and be used by the consumer as a shipping tube saving tremendous space, time and money in the process.

Long fluorescent light bulbs are protected by a polycarbonate clear and translucent tube sold in stores around the country. They go through the same space and money wasting procedure as the shipping tubes. The roll-a-pole will fill the need as it can be manufactured from the same strong plastic polycarbonate then rolled up in the techni-coil and shipped.

This space and money saving asset of the techni-coil and roll-a-pole applies to any of the roll-a-pole shapes shown in FIGS. 1 to 21 and many more that are described but not shown.

FIG. 3 shows a roll-a-pole that has been unrolled from its techni-coil state and is held flat by hand or mechanical means (not shown). It is then secured to the banner 69 by the fastener 58.

FIG. 4 shows the same roll-a-pole as shown in FIG. 3 still attached to the banner 69 but it has been rolled up into the techni-coil 30 and can be shipped in this condensed state.

FIG. 5 shows the same banner 69 and the techni-coil 30 shown in FIG. 4 but now they have been unrolled and the techni-coil has returned to its original formed shape as a roll-a-pole, still attached to the banner 69 and acting as a dowel providing rigid support. The lighting device 70 can be added to enhance advertising impact and is covered further in the FIG. 5, description section.

FIG. 6 shows the roll-a-pole in a round tubular shape but in this embodiment a flat section 36 has been added providing more support and increasing its structural strength.

FIG. 8 shows aground tube 87 that is being split down its center turning it into the roll-a-pole then it has been flattened at one end and partially rolled into the techni-coil. This operation can be applied to other tubular shapes such as a square and rectangle as long as their material and corners are of such a configuration as to allow this operation to be accomplished. An example would be a square tube with radius corners meeting the material shape and thickness requirements set forth in the description section. A stop tab has been added to retain the roll-a-pole at a given longitudinal length.

FIG. 9 shows a roll-a-pole clamp 77 securing two sheets of material. This unrolling clamp 77 can apply even pressure, for example, to lengths of plywood while being glued. Normally a number of individual “C” clamps would used. The pressure would be inconsistent as the load would be greatest at each clamp and far less in between. The pressure applied with each clamp would be different. The “C” clamps used would cost a lot more and take up more room in a toolbox. They would weigh a lot more than the roll-a-pole clamp and still not do as good a job. This is just one example of a use for the roll-a-pole clamp 77.

FIG. 10 shows the roll-a-pole snap lock tube 78. Its use is threefold, it can not only snap lock and seal while increasing its structural integrity but it can be used to construct frames with the use of the insert 63. It has the capability of securing materials as a single length and while in an assembled structure. The frame structure is shown more in FIG. 11 gripping a sheet of screen material 64. Slight variation in its design would allow it to secure a glass pane for example. Numerous frame arrangements are possible and are described more in the FIG. 11 description section.

FIG. 10A shows another roll-a-pole snap lock tube. The difference is the size and location of the locking device. This can have a dovetail male and female within its wall thickness allowing it to perform different tasks than its big brother in FIG. 10. It can be glued shut, if desired, creating a totally sealed round tube that could replace common sprinkle tubing or plumbing tube almost completely smooth on the inside and outside walls. The glue is not a necessity but an added feature to enhance strength and sealing properties. The uses for such a tube are endless not only as a structural element but also as a tube or pipe to carry liquids, gases, and act as a conduit.

FIG. 12 shows a roll-a-pole threaded tube 80. This embodiment can range in diameter as well as length. The threads can be coarse or fine, left or right handed, internal or external,

fabricated from metal or plastic and can have hundreds of applications. Joining and fastening threaded rods are commonly used when a length of adjustment is required in positioning or locating or pulling parts together, threaded tubes can be used with left hand threads on one end and right hand threads on the other along with common eye bolts to work as a turn buckle type of assembly. These are just some of the examples, many arrangements and uses are not mentioned for they are too numerous.

An abrasive 60 is also shown in FIG. 12. This abrasive can be applied to other roll-a-pole shapes not just the round tubular shape in FIG. 12. The file teeth 50 apply as well and either one or both might be applied to the same roll a-pole embodiment.

Normally when you use common sandpaper, a block of wood would be used as a support, commonly called a sanding block. The roll-a-pole with the abrasive has its own support and when the abrasive is worn; you pull another length of the roll-a-pole from its techni-coil and cut it to length for use. It's like unrolling a file or sanding block or both. The threads 48 and 49 would not normally be used on the same roll-a-pole as the abrasive 60 and the file teeth 50.

FIG. 13 shows a roll-a-pole push clamp 81. It can be used to secure posters, banners and various lightweight articles. It can be opened by pushing the lever 40 at the top then inserting the article to be retained and releasing the lever allows the gripping teeth 47 to grip. Just reverse the process to release the article. Magnetic material 59 can be added if the roll-a-pole push clamp is plastic and if the roll-a-pole push clamp is fabricated from steel it can be magnetized. This provides a means to mount the push clamp to a metal surface such as a refrigerator door or a door on a truck or car as well as other metal surfaces. Threaded holes 74 and through holes 75 can be used to provide additional pressure while clamping when a common bolt is applied to pull them together. They can also act as mounting features for walls or wood, etc.

FIG. 14 shows a roll-a-pole hinge 82 that can be used not only as a hinge but also a spring return hinge. It also has the capability of gripping sheets and other items. An adhesive or screws can be used to better secure the sheets, if desired. The roll-a-pole hinge can be made of metal or plastic; if plastic, adhesives common in the plastic industry could apply; if metal, spot welding, screws or rivets could be used. This type of hinge has hundreds of uses and can replace plastic and metal piano hinges presently on the market.

FIG. 15 shows a roll-a-pole corner molding 83. This embodiment most likely would be made from extruded plastic it too can replace common corner moldings on the market and is, able to grip sheets. It can be used along with the hinge 82 to construct an entire closed container or box with six sheets of material. The corner molding can be used to joins the bottom and sides of a box with five sheets of wood or plastic or even metal, and the hinge 82 can be used to attach the top sheet as a lid. The corner molding can take other shapes and is described further in the description section of FIG. 15.

FIG. 16 shows the container 72 used to retain the technical and to dispense the roll-a-pole from the techni-coil. This container can be used to retain any of the roll-a-pole embodiments shown and not shown as there are too many possible shapes and uses for different roll-a-pole embodiments. A blade 51 can be added to the container and be used to cut certain roll-a-poles to length.

FIG. 17 shows the turn key 73 and when assembled with the techni-coil and inserted into the container 72 it can be turned driving the techni-coil in and out of the container. When driven out it emerges as the roll-a-pole and when driven back it rolls up inside returning to its techni-coil state. This could be used in many roll-a-pole embodiments. One example is a measuring device shown in FIG. 18, like a yard stick, but can be much longer than a yard if desired. It is more like a yard stick than a common tape measure as they are not very rigid and cannot be fed out very far without collapsing. They have just about no structural integrity and are even weaker if turned on its side or upside down whereas the roll-a-pole is specifically designed to be rigid and can easily be extended 20 or 30 feet straight up or out. Regular tape measures extend 8 to 10 feet maximum and then collapse under its own weight. In FIG. 18 layered materials 54 can include paint or ink and other materials that can be applied to create measuring increments like numbers on yardsticks and other messages.

FIG. 18 shows the roll-a-pole “S” tube 84. It has a “S” shape 46 as an internal support and is another method of adding strength to the roll-a-pole embodiments similar to the flat section 36 shown in FIG. 6. More features have been added to the roll-a-pole in FIG. 18, the flat section 36 has been added providing a blade edge 51 and saw teeth 52. They can both be used for cutting. The ones presently used in industry require additional parts and structures to provide strength and rigidity as well as a handle device to grip. This is not necessary with the roll-a-pole for it provides strength, rigidity and a handle all in its tube like construction.

Saw blades and knife blades wear out and need to be changed; with the roll-a-pole another length can be unrolled off the techni-coil providing a new knife blade or length of saw teeth.

The flat section 36 can be extended further to act as a sign face, if desired. Its surface may be used to apply numbers creating a type of yard stick mentioned in operations of FIG. 17.

FIG. 19 shows the roll-a-pole eye tube 85, a completely closed tubular shape which can be used in hundreds of applications where tubes, pipes and hoses are used. The fact that it is completely sealed all the way around creates a new type of roll-a-pole to carry liquid, gas, conduit, etc. FIGS. 10 and 10A as well as FIG. 6, show roll-a-pole embodiments that are open and flattened out like a sheet to be rolled into the techni-coil. The eye tube does not work that way, as it is a sealed tubular shape as a roll-a-pole in an extruded length and is still flattened out at one end but does not open like a flat sheet. It retains its sealed tubular configuration while being rolled into the techni-coil and when unrolled again into the roll-a-pole, it emerges like a rigid hose, tube or pipe.

FIG. 20 shows the roll-a-pole quad tube 86, it is constructed of the eye tube 85 in plurality or of pieces of the eye tube described in FIG. 20 description section. It has the same properties and applications but can take other shapes and can have multiple sealed tubular constructions as a round tube or even a square tube with sharp corners. This is covered in the description section as well.

FIG. 21 shows the roll-a-pole frame 79. The frame 79 was also shown in FIG. 11. The roll-a-pole frame can be assembled from many different roll-a-pole embodiments shown and not shown and can be assembled in many different ways and arrangements.

This particular frame arrangement is constructed from a single length of the roll-a-pole which has a round tubular construction. It can be bent in four corners creating a type of square frame. The two open ends fit together, one into the other as they can compress and expand in their diameter. One end can also have flexing button features that snap through the buttonholes in the other end and lock in position. Numerous buttonholes can be added to allow the other tube multiple locking positions. The partially shown banner 69 can be hung from the frame and they can together be hung from wires tied to a ceiling making a one piece hanging frame.

Shapes of roll-a-poles can be altered and rearranged to fit hundreds of application, the uses are numerous.

Features extruded or formed into the roll-a-poles are shown in certain shapes, styles and sizes as possible examples and may very well as be mixed and matched in other embodiments shown and not shown.

Added features whether co-extruded or fabricated in second operations are just sample features and methods of fastening, gripping, locking, etc. They may all vary in shape, size and style as well as mixed and matched throughout various embodiments shown and not shown.

The fact that the roll-a-pole is a type of spring with moving parts and can have multiple accessories added or incorporated as well as take numerous applications makes it a machine with stored spring energy that can perform useful work but can be rolled up into a compressed techni-coil form. This makes its applications and uses too vast to all be illustrated or described.

Shapes of most extruded and formed products, which are not roll-a-poles, are designed for a specific use. It is known in industry that such products may also have uses of a universal nature. A PVC pipe for example, by its very name, suggests that its intended to be used as a pipe to carry fluids, gases, etc. It may also be used as a rod, a post, a dowel; frames may be built with it as support structures, cages etc. We see them in patio furniture, in tools and even in machinery.

Those shapes of the roll-a-pole when used in a manner and purpose of similar extruded and formed products known to be of rigid lengths, because they were not designed with the roll-a-pole in mind, may of course replace those rigid lengths.

Features such as wires of various sizes and shapes used as a conductor, a connector etc. Other features such as fiber optics, tubes made of flexible materials, magnetic strips or particles, electronic components, such as identification implants, electronic circuits and a myriad of other elements, that may be encased into the roll-a-pole during its manufacturing phase and those which are added such as holes, notches and shapes that perform mechanical feats, etc., all become uses of the roll-a-pole. Features with attributes of the kind stated herein, depicted within the figures, of the “Detailed Description” are intended as examples.

We claim:

1. A coiled linear and tubular formed shape(s) comprising:
A length of thin walled material having strong spring like properties, the same or close to those found in polycarbonate plastic fluorescent light bulb protectors and those found in spring steel tape measures. Extruded or formed metal or plastic comprising a linear formed shape whose end view exhibits lines of transition as tangential and contains any of the following configurations:
(1) A circular, curved or other geometric configured shape with open or overlapping edges.
(2) A multitude of curved shapes.
(3) A multitude of linear combined with a curved shape.
(4) A multitude of linear combined with a multitude of curved shapes.
(5) A multitude of curved shapes combined with a linear shape.
(6) A linear combined with a curved shape.
And when formed in any of these said configurations, then flattened at one end and rolled perpendicular to its length into a coiled form, then uncoiled returns close to its original formed shape due to its spring properties; thereby said shaped configurations provide structural support and rigid stability; and said inherent spring characteristics provide movement and stored spring energy to perform work such as gripping, clamping, snapping, locking, fastening, flexing, hinging, expanding and contracting; said shapes can be flattened at one end and rolled perpendicular to their length into a coiled form repeatedly, if desired.

2. The overlapping curved shape(s) and others described in claim 1
provide structural support for relatively light objects such as banners, electric wire(s), objects commonly held in shipping tubes, etc. These mentioned shapes are self supporting as well, and can be used as yard sticks or far reaching tape measures when markings are incorporated to provide a means of measuring.

3. The overlapping shapes of claim 1
may also employ snapping and locking features as one surface may have a female configuration and the other surface a male allowing one to flex and snap into the other thereby fastening. Adhesives and other common fastening and sealing means may be incorporated whereby, liquids, gases, or solids may be contained or passed through said shapes.

4. The formed shape(s) of claim 1
wherein a percent of the material is metallic and capable of conducting electricity therefore providing a type of rigid wire that can be uncoiled to form straight lengths.

5. The formed shape(s) of claim 1
fabricated of a multitude of materials layered or co-extruded; a multitude of curved spring material shapes attached to one or more flexible softer materials such as rubber or vinyl plastic, etc. providing a soft, flexible hinge and can completely seal the spring material enclosing them and forming a sealed cylindrical shape. The curved spring can be flattened while still held together by the flexible soft hinge material, and then rolled at one end perpendicular to its length into the said coil shape. When uncoiled a tube or hose shape is revealed completely sealed in its length whereby gases, liquids, and solids can flow as we now have an uncoiling rigid tube or a rigid hose.

6. The formed shape(s) of claim 1
where certain configurations have opposing surfaces that are capable of clamping when materials are forced within these surfaces due to the inherent spring energy. Clamping occurs in other configurations where opposing surfaces can be forced open due to the flexing of built in mechanical components such as a lever. Other curved shapes compress or expand to clamp as internal or external resistance is present. These clamping configurations can mount to surfaces by common fastening means. When adhesives are used on the mounting surface of the said formed shape, a type of mechanical tape is created that unrolls from a coil and adheres to a surface it then can clamp or fasten material repeatedly.

7. The formed shape(s) of claim 1
whereby the said plastic material is transparent or translucent allowing internal vision or allowing light to pass through its wall to enhance advertising when used on signs or banners or other applications where a clear or translucent tubular shape might be employed.

8. The formed shape(s) of claim 1
whereby the flexing action acts as a spring.

9. The formed shape(s) of claim 1
whereby its shape allows it to act as a molding or trim for corners, edges and other surfaces; clamping characteristics and fastening methods such as adhesives may be incorporated to secure the molding.

10. The formed shape(s) of claim 1
may be assembled by couplings or corner inserts, shaped to change direction or create intersections, this type of assembly may be used as cord covers to carry wire around corners or assemble light weight frame configurations.
